(19) United States
(12) Patent Application Publication
(10) Pub. No.: US 2015/0052098 A1
(43) Pub. Date: Feb. 19, 2015

(54) CONTEXTUALLY PROPAGATING SEMANTIC KNOWLEDGE OVER LARGE DATASETS

(71) Applicants: Branislav Kveton, Palo Alto, CA (US); Gayatree Ganu, Piscataway, NJ (US); Yoann Pascal Bourse, Estrees (FR); Osnat Mokryn, Haifa (IL); Christophe Diot, Palo Alto, CA (US)

(72) Inventors: Branislav Kveton, Palo Alto, CA (US); Gayatree Ganu, Piscataway, NJ (US); Yoann Pascal Bourse, Estrees (FR); Osnat Mokryn, Haifa (IL); Christophe Diot, Palo Alto, CA (US)

(73) Assignee: Thomson Licensing, Issy de Moulineaux (FR)

(21) Appl. No.: 14/389,787

(22) PCT Filed: Apr. 5, 2012
(86) PCT No.: PCT/US2012/032287

§ 371 Date: Oct. 1, 2014

(51) Int. Cl. G06N 7/00; G06F 17/30; G06N 99/00

(52) U.S. Cl. CPC G06N 7/005; G06N 99/005; G06F 17/30864
USPC 706/52

(57) ABSTRACT

A method for operation of a search and recommendation engine via an internet website is described. The website operates on a server computer system and includes accepting text of a product review or a service review, initializing a set of words with seed words, predicting meanings of the words in the set of words based on confidence scores inferred from a graph and using the meanings of the words to make a recommendation for the product or the service that was a subject of the product review or the service review. The search and recommendation engine is also described.

### FIELD OF THE INVENTION

The present invention relates to text classification of users' reviews and social information filtering and recommendations.

### BACKGROUND OF THE INVENTION

The recent Web 2.0 explosion of user content has resulted in the generation of a large amount of peer-authored textual information in the form of reviews, blogs and forums. However, most online peer-opinion systems rely only on the limited structured metadata for aggregation and filtering. Users often face the daunting task of sifting through the plethora of detailed textual data to find information on specific topics important to them.

In recent years, online reviewing sites have increased both in number and popularity resulting in a large amount of user generated opinions on the Web. User reviews on people, products and services are now treated as an important information resource by consumers as well as a viable and accurate user feedback option by businesses. Reviewing sites, in turn, have several mechanisms in place to encourage users to write long and highly detailed reviews. Friendships and followers networks, badges and “helpful” tags have made on-line review writing a social activity, resulting in an explosion of quantity and quality information available in reviews. According to a marketing survey, online reviews are second only to word of mouth in purchasing influence. Yet, websites have surprisingly poor mechanisms for capturing the large amount of information and presenting it to the user in a systematic controlled manner

Most online reviewing sites use a very limited amount of information available in reviews, often relying solely on structured metadata. Metadata like cuisine type, price range and location for restaurants or genre, director and release date for movies provide usable information for filtering to find items that are more likely to be relevant to the user. Yet, users often do not know what they are looking for and have fuzzy, subjective and temporally changing needs. For example, a user might be interested in eating at a restaurant with a good ambience. A wide range of factors like pleasant lighting, modern vibe or live music can imply that the restaurant ambience is good. Several popular reviewing web-sites like TripAdvisor and Yelp have recognized the need for presenting fine-grained information on different product features. However, the majority of this information is gathered by asking reviewers several binary yes-no questions, making the task of writing reviews very daunting. User experience would be greatly improved if information on specific topics, like the Food or Ambience for a restaurant, was automatically leveraged from the free-form textual content. In addition, websites commonly rely on the average star rating as the only indicator of the quality of the items. However, star ratings are very coarse and fail to capture the detailed assessment of the item present in the textual component of reviews. Users may be interested in different features of the items. Consider the following example:
EXAMPLE 1: On Yelp, a popular restaurant EatHere (name hidden) has an average star rating of 4 stars (out of a possible 5 stars) across 447 reviews. However, a majority of the reviews praise the views and ambience of the restaurant while complaining about the wait and the food, as shown from the following sentences extracted from the reviews:
   If you're willing to navigate through an overflowing parking lot, wait for an hour or more to be seated, and deal with some pretty slow service, the view while you're eating is pretty awesome . . . .
   The view is spectacular. Even on a greyish day it is still beautiful. Look past the pricey and basic food.
   The burger . . . was NOT worth it. Greasy, and small . . . . The view is amazing

The negative reviews complain at length about the poor service, long wait and mediocre food. For a user not interested in the ambience or views, this would be a poor restaurant recommendation. The average star ratings will not reflect the quality of the restaurant along such specific user preferences.

Searching for the right information in the text is often frustrating and time consuming. Keyword searches typically do not provide good results, as the same keywords routinely appear in good and in bad reviews. Recent studies have focused on feature selection and clustering on these features. However, feature clustering as described in the prior art does not guarantee semantic coherence between the clustered features. As described above, users looking for restaurants with a good ambience might be interested in knowing about several features like the music and lighting. Therefore, users would benefit for a semantically meaningful clustering of features into topics important to the users. Utilizing existing taxonomies like Wordnet for such semantically coherent clustering often is very restrictive for capturing domain specific terms and their meaning: in the restaurant domain the text contains several proper nouns of dishes like Pho, Biryani or Nigiri, certain colloquial words like “apps” (implying appetizers) and “yum” (implying delicious), and certain words like “starter” which have definite and different meanings based on the domain (automobile reviews vs. restaurant reviews) which Wordnet will fail to capture.

Online reviews are a useful resource for tapping into the vibe of the customers. Identifying both topical and sentiment information in the text of a review is an open research question. Review processing has focused on identifying sentiments, product features or a combination of both. The present invention follows a principled approach to feature detection, by detecting the topics covered in the reviews. Recent studies show that predicting a user's emphasis on individual aspects helps in predicting the overall rating. One prior art study found aspects in review sentences using supervised methods and manual annotation of a large training set while the present invention does not require hand labeling of data. Another prior art method uses a boot-strapping method to learn the words belonging to the aspects assuming that words co-occurring in sentences with seed words belong to the same aspect as the seed words.

Several studies have focused on using a word co-occurrence model for clustering words or understanding the meaning and sense of words. In one prior art study, the authors study word meanings using word co-occurrences. They explore the use of a variable window around the words to avoid considering wrong co-occurrences due to multiple concepts in the same sentence. However, they do not use contextual information directly in the understanding of word meanings. Since sentences can have many phrases referring to different aspects, the context descriptors in the present invention serve as a window of words around the word of interest that are more precise (descriptors built from coherent phrases will be more frequent and hence have higher weights in a dataset used with the present invention). In yet another prior art study, the authors use word co-occurrences to distinguish between the different senses of words. Another study assesses the likelihood of two words co-occurring using similarity between words, again learned for word co-occurrences. The present invention differs from these previous studies by using the contextual information directly into the inference building and avoids erroneous word association. For instance, in the restaurant reviews dataset, descriptors such as “is cheap” and “looks cheap” were encountered. The present invention was able to distinguish between the terms referring to the cost of food at a restaurant and the decor of the restaurant.

Bootstrapping methods that learn from large datasets have been used for named entity extraction and relation extraction. It is believed that the present invention is the first work that uses bootstrapping methods for semantic information propagation. In addition, earlier studies restricted content descriptors to fit specific regular expressions. The techniques of the present invention demonstrate that with large data sets, such restrictions need not be imposed. Lastly, these systems relied on inference in one iteration to feed into the evaluation of nodes generated in the next iteration. A good descriptor was one that found a large percentage of “known” (from earlier iterations) good words. The present invention does not iteratively label nodes in the graph, and assumes no inference on non-seed nodes in the graph. Hence, the present invention is not susceptible to finding a local optima with limited global knowledge over the inference on the graphs.

A popular method in prior art text analysis is clustering words based on their co-occurrences in the textual sentences. It is believed that such clustering is not suitable for analyzing user reviews as the resulting clusters are often not semantically coherent. Reviews are typically small, and users often express opinions on several topics in the same sentence. For instance, in a restaurant reviews corpus it was found that the words “food” and “service” which belong to obviously different restaurant aspects co-occur almost 10 times as often as the words “food” and “chicken”. A semi-supervised model that relies on building topical taxonomies from the context around words is proposed. While semantically dissimilar words are often used in the same sentence, the descriptive context around the words is similar for thematically linked words. For instance, one would never expect to see the phrase “service is delicious” and the contextual descriptor “is delicious” could be used to group words under the food topic. Exhaustive taxonomies for specific domains do not exist. The present invention builds such a taxonomy from the domain data, without relying on any supervision or external resources.

### SUMMARY OF THE INVENTION

The present invention proposes a semi-supervised system that automatically analyzes user reviews to identify the topics covered in the text. The method of the present invention bootstraps from a small seed set of topic representatives and relies on the contextual information to learn the distribution of topics across large amounts of text. Results show that topic discovery guided by contextual information is more precise, even for obscure and infrequent terms, than models that do not use context. As an application, the utility of the learned topical information is demonstrated in a recommendation scenario.

The present invention proposes a semi-supervised algorithm that bootstraps from a handful of seed words, which are representative of the clusters of interest. The method of the present invention then iteratively learns descriptors and new words from the data, while learning the inference or class membership confidence scores associated with each word and contextual descriptor. Random walks on graphs to compute the harmonic solution are used for propagating class membership information on a graph of words. The label propagation is strongly guided by the contextual information resulting in high precision on confidence scores. Therefore, the method of the present invention clusters a large amount of data into semantically coherent clusters, in a semi-supervised manner with only a handful cluster representative seed words as inputs. In particular, the following contributions are made:
A novel semi-supervised method for classifying textual information along semantically meaningful dimensions is described. The boot-strapping method of the present invention results in a semantically meaningful clustering not just over the content (words) but also over the context (descriptors).
Cluster membership probabilities for the different words and context descriptors are “learned” using closed form random walks over the bipartite graph of words and descriptors. Unlike greedy methods, the method of the present invention is not susceptible to finding local optima and finds stable inference. The precision of the returned results of the method of the present invention is compared with the popular method that builds inference on a word co-occurrence graph. Experiments show that using contextual information greatly improves classification results using two large datasets from the restaurants and hotels domains.
Lastly, the topic classification confidence scores associated with each word and context descriptor in the corpora are used in a recommendation scenario and demonstrate the usefulness of text in improving prediction accuracy.

A method for operation of a search and recommendation engine via an internet website is described. The website operates on a server computer system and includes accepting text of a product review or a service review, initializing a set of words with seed words, predicting meanings of the words in the set of words based on confidence scores inferred from a graph and using the meanings of the words to make a recommendation for the product or the service that was a subject of the product review or the service review. The search and recommendation engine is also described including a generate bipartite graph module, a generate adjacency graph module, the generate adjacency graph module in communication with the generate bipartite graph module, a predict confidence score module, the predict confidence score module in communication with the generate adjacency graph module and a recommendations module, the recommendations module in communication with the predict confidence score module.

### BRIEF DESCRIPTION OF THE DRAWINGS

The present invention is best understood from the following detailed description when read in conjunction with the accompanying drawings. The drawings include the following figures briefly described below:

FIG. 1 is an example of the contextually driven iterative method of the present invention.

FIG. 2 shows the precision at K for the five semantic categories computed on the contextually guided bipartite graph in the restaurant review dataset.

FIG. 3 shows the precision at K for the five semantic categories computed on the noun co-occurrence graph for the five semantic categories in the restaurant review dataset.

FIG. 4 shows the precision at K for the five semantic categories computed on the co-occurrence graph built on all restaurant words.

FIG. 5 shows the precision at K for the six semantic categories computed on the contextually guided bipartite graph in the hotel review dataset.

FIG. 6 shows the precision at K for the six semantic categories computed on the noun co-occurrence graph for the five semantic categories in the hotel review dataset.

FIG. 7 shows the precision at K for the six semantic categories computed on the co-occurrence graph built on all hotel words.

FIG. 8 is a flowchart of an exemplary method of the present invention.

FIG. 9 is a flowchart of an expanded view of the prediction of the meaning of words based on confidence scores inferred from a graph portion (reference 815 of FIG. 8) of the method of the present invention.

FIG. 10 is a flowchart of an expanded view of building a bipartite graph portion (references 905 and 920 of FIG. 9) of the method of the present invention.

FIG. 11 is a block diagram of an exemplary implementation of the present invention.

### DETAILED DESCRIPTION OF THE PREFERRED EMBODIMENTS

The present invention clusters the large amount of text available in user reviews along important dimensions of the domain. For instance, the popular website TripAdvisor identifies the following six dimensions for user opinions on Hotels: Location, Service, Cleanliness, Room, Food and Price. The present invention clusters the free-form textual data present in user reviews via propagation of semantic meaning using contextual information as described below. The contextually based method of the present invention results in learning inference over a bipartite (words, context descriptors) graph. A similar semantic propagation over a word co-occurrence graph that does not utilize the context is also described below. The two methods are then compared.

The present invention is a novel method for clustering the free-form textual information present in reviews along semantically coherent dimensions. The semi-supervised algorithm of the present invention requires only the input seed words representing the semantic class, and relies completely on the data to derive a domain-dependent clustering of both the content words and the context descriptors. Such semantically coherent clustering allows users to access the rich information present in the text in a convenient manner

Classification of textual information into domain specific classes is a notably hard task. Several supervised approaches have been shown to be successful. However, these methods require a large effort of manual labeling of training examples. Moreover, if the classification dimensions change or if a user specifies a new class he/she is interested in, new training instances have to be labeled. The present invention requires no labeling of training instances and can bootstrap from a few handful of class representative instances.

The present invention takes as input a few seed words (typically 3-5 seed words) representative of the semantic class of interest. For instance, while classifying hotel review text in the cluster of words semantically related to “service”, “service, staff, receptionist and personnel” were used as seed words. Although the present invention benefits from frequent and non-specific seeds, it quickly learns synonyms and it is not very sensitive to the initial selection of seeds.

Bootstrapping from the seed words, the present invention runs in two alternate iteration steps. In the first step, the present invention “learns” contextual descriptors around the candidate words (in the first iteration, the seed words are the only candidate words). The contextual descriptors include one to five words appearing before, after or both before and after the seed words in review sentences. For every occurrence of a seed word there is a maximum of about 19 context descriptors. Note that, to keep the present invention reasonably simple there are no restrictions on the words in the contextual descriptors; the descriptors often have verbs, adjectives and determinants. With large data sets, it is not necessary to find regular expressions fitting the various context descriptors; the free-form text neighboring words are sufficient. The list of descriptors is pruned to remove descriptors including only stop words and to remove descriptors that appear in less than 0.005% sentences of our data. For instance, a descriptor like “the” is not very informative. Out of the exponentially many descriptors created from the candidate set, only discriminative descriptors are used for growing the graph as described below.

Similarly, in the alternate iteration the present invention learns content words from the text that fit the candidate list of descriptors from the earlier iteration. This step is restricted to finding nouns, as the semantic meaning is often carried in the nouns in a sentence. In addition, the present invention is restricted to finding nouns that occur at least ten times in the corpus of the data, in order to avoid strange misspellings and to make the computation tractable. Discriminative words are then used as candidates for the subsequent iteration.

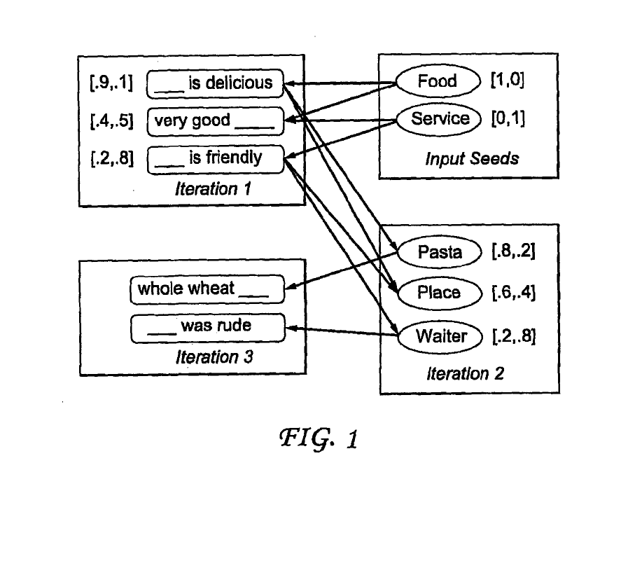

FIG. 1 is an example run of the method of the present invention where restaurant review text is classified as either Food or Service. For each class, there is one seed word with a 100% confidence of belonging to the class. The method of the present invention is then executed on the entire dataset to find descriptors. Some descriptors like “is delicious” appear almost always with food while others like “very good” are not discriminative. The semantics propagation method “learns” the discriminative quality of the descriptors and assigns confidence scores to them. In the next iteration only those descriptors that pass a threshold on the discriminative property are used as candidate descriptors for finding new words. The iterations stop when there are no more candidate descriptors or words to expand the graph. Thus, a bipartite descriptors-words graph is generated. The bipartite graph is selectively expanded in each iteration.

Propagation of meaning from known seed words to other nodes in the graph depends critically on the construction of the graph. The weights on the edges of the graph have to represent the knowledge in the domain. At each iteration there is a graph G(V,E) where the vertices V are the sum of content words V_{w} and the context descriptors V_{d} and the edges E link a word to the descriptors that occurs within the data. A point-wise mutual information based score is assigned as the weight on the edge. Since semantics are propagated via random walks over large graphs with several words and context descriptors, a strong edge in the graph should have an exponentially higher weight than weaker edges. Therefore, the PMI weights are exponentiated. For an edge connecting the word i and the context descriptor j, the edge weight aᵢⱼ is given by the following score:

Edge Weight aᵢⱼ=max[P(i∩j)/(P(i)P(j))−1, 0] (1)

In the above equation, the co-occurrence probability P(i∩j) is estimated as the count of the co-occurrence instances of the word i and the context descriptor j in the dataset. It is time consuming and inefficient to enumerate all possible context descriptors and assess their frequencies. Therefore, the context node probability P(j) is estimated as the number of times the descriptor j occurs in the corpus (body of data, dataset). As a pre-processing step all nouns N in the dataset are enumerated and the word probability P(i) is estimated as the proportion of words i to all the nouns in the dataset. Therefore, the edge weight computation uses the following probability computations:

P(i∩j)=#(i∩j), P(i)=#(i)/Σ_{N}#(N)), P(j)=#(j)

The edge scoring function of the present invention has the nice properties that for extremely rare chance co-occurrences, it reduces the edge weight to zero. In addition, due to the normalization by P(i) and P(j) edges that connect extremely common nodes that link to many nodes in the graph and are, therefore, not very discriminative will have lower weights. Once an adjacency matrix A_{i×j} representing the bipartite graph of content words and context descriptors has been generated, meaning of this graph starting only from the handful of seed nodes is propagated as described below.

For semantics propagation, a conventional harmonic solution is introduced. The harmonic solution algorithm solves a set of linear equations so that the predicted confidence scores on non-seed nodes is the average of the predicted confidence scores of its non-seed neighbors and the known fixed confidence scores of the seed nodes. Therefore, for each node in the graph the algorithm learns the confidence score belonging to every cluster.

Using the edge weight scores of Equation (1), the adjacency matrix A_{i×j} for i words and j descriptors is constructed. This adjacency matrix is non-symmetric.

Therefore, a symmetric matrix W is constructed as follows:

$$W = \vert \begin{matrix}0 & {A}_{i \times j} \\ {A}_{i \times j}^{T} & 0\end{matrix} \vert$$

Now, let D be the diagonal degree matrix with Dᵢᵢ=Σᵢⱼ. The diagonal matrix is modified to add a regularization parameter γ which accounts for the probability of belonging to an unknown class. This regularization implies that all words in the corpus are not forced to belong to either one of the topics of interest, and allow ambiguous words to belong to an unknown class. Therefore, the diagonal matrix is computed as Dᵢᵢ=Σⱼ Wᵢⱼ+γ. The Laplacian is defined as L=D−W. A harmonic solution on the Laplacian L treats all neighbors of a non-seed node with equal importance. It does not take into account that certain neighbors having large degrees should be less influential in contributing to the confidence scores, as these nodes are not very discriminative. Hence, the normalized Laplacian matrix Lₙ constructed as Lₙ=I−W D^{-0.5} is used. Essentially, in the computation of the confidence score for a non-seed node, neighbors are rebated by their degrees. Neighbors with a large degree do not bias the confidence score estimates. Let the seed words be denoted by l and the non-seed nodes with unknown cluster membership be u, such that the total vertices in the graph |V|=l+u. The harmonic solution is given by:

lᵤₖ=−((Lₙ)ᵤₙ)⁻¹(Lₙ)ᵤₗlₗₖ, (2)

where lᵤₖ is a vector of probabilities that nodes iεu belong to the class k and lₗₖ is a vector of indicators that seed words iεl belongs to the class k. Equation 2 is computed for all classes k.

The harmonic solution gives stable probability estimates and, since in each iteration, only the initial seed words are considered as known nodes with fixed probabilities and propagate the meaning on the graph, no unnecessary errors are introduced. For instance, a descriptor that initially seems to link to only “food” words may in subsequent iterations link to new words found to belong to different classes. In this case, propagating the “food” label from this descriptor would have resulted in trickling the error in subsequent iterations. The present invention resolves this issue by computing inference using only the seed words as known words with fixed probabilities.

At each iteration of the present invention, only the very discriminative words or descriptors are used as candidates for growing the graph. The discriminative property of a node in the graph is computed (determined) using entropy. Entropy quantifies the certainty of a node belonging to a cluster, a low entropy indicates high certainty. Entropy for a node n in the graph having confidence scores cᵢ(n) across the i semantic classes is computed as:

E(n)=−Σᵢcᵢ(n)log cᵢ(n)

In experiments, at each iteration nodes that pass a threshold on the entropy value as candidates for finding new nodes and growing the graph are used. The entropy threshold is set to 0.5, which has been shown to perform well in selecting discriminative candidates.

Previous work in analyzing textual content and understanding the semantics of words has focused around building a word co-occurrence graph. Several studies have tried different scoring mechanisms and word statistics to build this graph. While the word co-occurrences models try to capture contextual information, using contextual phrases in the model to guide the semantics propagation is important and useful. In order to validate this hypothesis, a comparable word co-occurrence graph was built using the scoring function in Equation (1), without using the context but based only on co-occurrence of words in review sentences. In other words, there is no word-descriptors bipartite graph. Additionally, the same semantic propagation method described above was used and fed as input the same seed words with known fixed confidence scores. Below, the utility of using context is shown by comparing the precision of the results between the word co-occurrence model described here and the contextual model of the present invention described above.

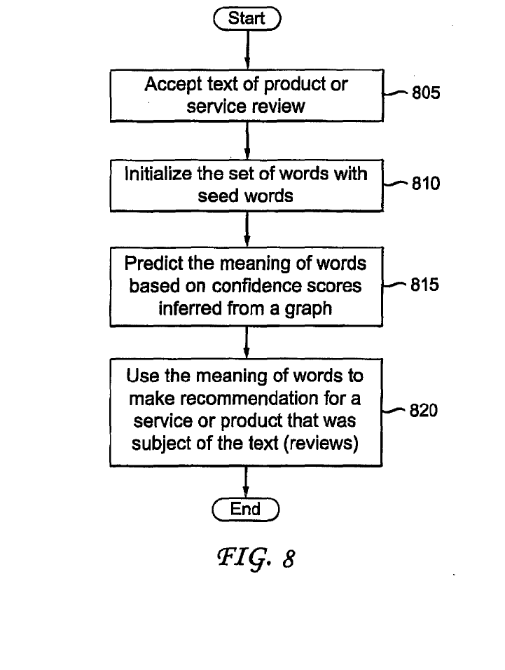

FIG. 8 is a flowchart of an exemplary method of the present invention. At 805 the method of the present invention accepts the text of product or service reviews. At 810 a set of words is initialized with seed words. At 815 the meaning of words are predicted based on confidence scores are inferred from a graph. At 820 the confidence scores are used to make recommendations for a service or product that was the subject of the text (reviews).

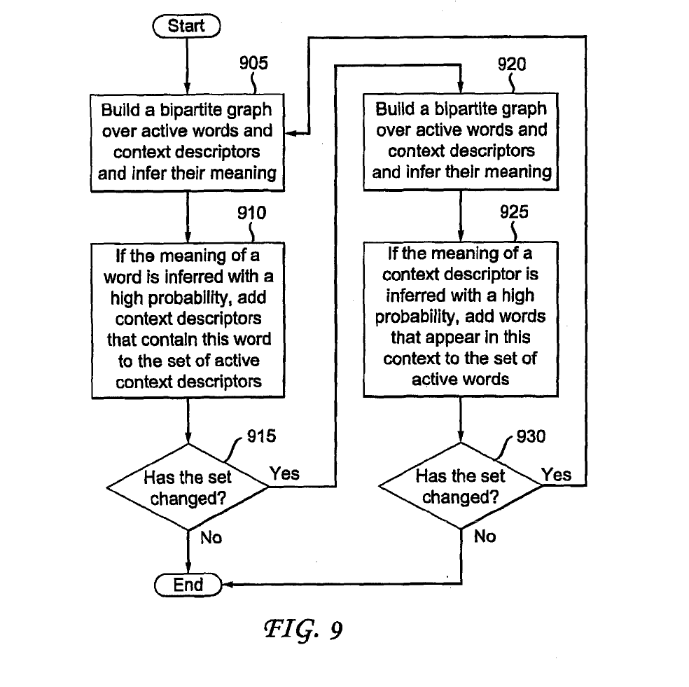

FIG. 9 is a flowchart of an expanded view of the prediction of the meaning of words based on confidence scores inferred from a graph portion (reference 815 of FIG. 8) of the method of the present invention. The nodes of the bipartite graph are the words and descriptors. The weights on the edges of the bipartite graph represent knowledge in the domain. The edges link words to context descriptors that occur within the data. The weights are point-wise mutual information-based scores. The higher the weight, the stronger the score. At 905 a bipartite graph is built over active words and context descriptors and their meaning is inferred. At 910 if the meaning of a word is inferred with high probability then the context descriptors that include the word are added to the set of active context descriptors. At 915 a test is performed to determine if the data set of context descriptors has changed (by the addition of context descriptors). If the data set has not changed, then the process ends. If the data set has changed then the process continues at 920. At 920 the bipartite graph is built over active words and context descriptors and their meaning is inferred. The candidate context descriptors set is pruned. The set of candidate context descriptors are pruned to include only “stop” words and to a maximum of 19 words. Candidate context descriptors occurring in less than 0.005% of the sentences in the text (reviews) are deleted (pruned, dropped). At 925 if the meaning of a context descriptor is inferred with high probability then the words that appear in this context descriptor are added to the set of active words. At 930 a test is performed to determine if the data set of words has changed (by the addition of words). If the data set has not changed, then the process ends. If the data set has changed then the process continues at 905. New words are non-seed words and are nouns only that occur at least ten times in the corpus of data (text of all reviews of the service or product). This limits the words (seed and non-seed) and context descriptors to those that are discriminative. In the above embodiment, a new bipartite graph is built at every iteration. In an alternative embodiment, a bipartite graph is built initially and subsequent iterations update the already built bipartite graph. The alternative embodiment is a design choice and a matter of efficiency. In the alternative embodiment, which is not shown, 920 would not indicate that the bipartite graph is built but rather that the bipartite graph is updated.

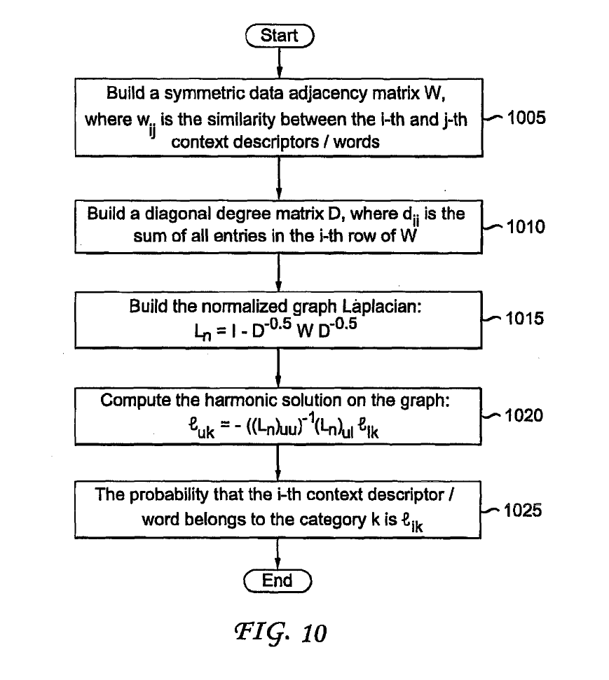

FIG. 10 is a flowchart of an expanded view of building a bipartite graph portion (references 905 and 920 of FIG. 9) of the method of the present invention. FIG. 10 is used for the generation of bipartite graphs for word and context descriptors so the method of FIG. 10 is used for both reference 905 and 920. At 1005, a symmetric data adjacency matrix W is built where wᵢⱼ is the similarity between the i^{th} and j^{th} context descriptors or words. At 1010 a diagonal degree matrix D is built where dᵢⱼ is the sum of all entries in the i^{th} row of symmetric adjacency matrix W. At 1015 a normalized graph Laplacian Lₙ=I−D^{-0.5}WD^{-0.5} is constructed (built). The prediction of confidence scores is accomplished by a harmonic solution of a set of linear equations such that the predicted confidence scores on non-seed nodes in the bipartite graph is the average of the predicted confidence scores of its non-seed neighbors and the confidence scores of seed nodes. At 1020 the harmonic solution [lᵤₖ=−((Lₙ)ᵤᵤ)⁻¹(Lₙ)ᵤₗlₗₖ] on the graph is computed (calculated). The harmonic solution (prediction of confidence scores) can be thought of as a gradient walk starting from a non-seed node, ending in a seed node and at each step hopping to the neighbor with the highest score (next highest score after itself). At 1025 the probability that the i^{th} context descriptor or word belongs to the category k is lₗₖ.

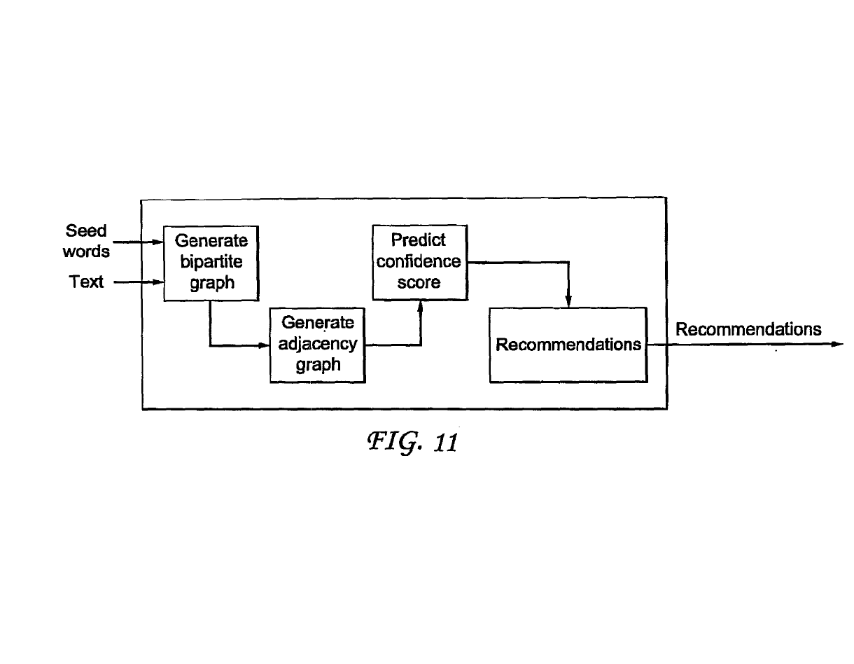

FIG. 11 is a block diagram of an exemplary implementation of the present invention. There is a generate bipartite graph module that accepts (receives) seed words and text (sentences from a review). The generate bipartite graph module outputs words and context descriptors to the generate adjacency matrix module. The generate adjacency matrix module outputs the adjacency matrix to the predict confidence scores module. The confidence scores generated by the predict confidence scores module is used by a recommendations module to make recommendations for a service or product that was the subject of the text (reviews). The present invention is effectively a search and recommendation engine operated via an Internet website, which operates on a server computing system. The Internet website is accessible by users using a computer, a laptop or a mobile terminal A mobile terminal includes a personal digital assistant (PDA), a dual mode smart phone, an iphone, an ipad, an ipod, a tablet or any equivalent mobile device.

Two large datasets from popular online reviewing websites were crawled: the restaurant reviews dataset and the hotel reviews dataset. Both these datasets have very different properties as described below and summarized in Table 1. Yet, the present invention is easily applicable to these diverse large datasets and manages to find very precise semantic clusters as shown below.

TABLE 1

| | Restaurants | Hotels |
|---|---|---|
| Reviews | 37224 | 137234 |
| Businesses | 2122 | 3370 |
| Users | 18743 | No unique user identifiers |
| | | available |
| Average length (sentences) | 9.3 | 7.1 |
| Distinct nouns | 8482 | 11212 |
| Average star rating (1.5) | 3.77 | 3.65 |
| Average topic-wise rating | N/A | Cleanliness (4.33); service |
| (1.5) | | (4.01); spaciousness (3.87); |
| | | location (4.19); value |
| | | (3.91); sleep quality (4.01) |

The restaurant reviews dataset has 37K reviews from restaurants in San Francisco. The openNLP toolkit for sentence delimiting and part-of-speech tagging was used. The restaurant reviews have 344K sentences. A review in the corpus of data is rather long with 9.3 sentences on average. In addition, the vocabulary in the restaurant reviews corpus is very diverse. The openNLP toolkit was used to detect the nouns in the data. The nouns were analyzed since they carry the semantic information in the text. To avoid spelling mistakes and idiosyncratic word formulations, the list of nouns was cleaned and the nouns that occurred at least 10 times in the corpus were retained. The restaurant reviews dataset contains 8482 distinct nouns of which, a semantic confidence score of belonging to different classes was assigned. In addition to the text, the restaurant reviews only contain a numerical star rating and not much else usable semantic information.

On the other hand, the hotel reviews are not very long or diverse. The hotel reviews dataset is much larger with 137K reviews. However, the average number of sentences in a review is only seven sentences. The hotel reviews do not have a very diverse vocabulary, despite four times as many reviews as the restaurants corpus, the number of distinct nouns in the hotel reviews data is 11K. However, the hotel reviews have useful metadata associated with them. In addition to the numeric star ratings on the overall quality of the hotel, reviewers rate six different aspects of the hotel: cleanliness, spaciousness, service, location, value and sleep quality. These hotel aspects provide a well defined pre-existing semantic categories into which to cluster words as well as a some ground truth to validate the present invention.

Using contextual information is useful in controlling semantic propagation on a graph of words. The context provides strong semantic links between words; words with similar meanings are encapsulated with the same contextual descriptors. The performance of semantics propagation by the random walk on the contextual bipartite graph of words is compared with the inference on the word co-occurrence graph.

Five semantic categories are defined for the restaurants domain: Food, Price, Service, Ambience, Social intent. The first four categories are typical categories used by Zagat to evaluate restaurants. On analyzing the data, several instances were found that described the purpose of the visit which can provide useful information to a reader; the Social intent category is meant to capture this topic. Only a handful of seed words for each category were used: Food (food, dessert, appetizer, appetizers), Price (price, cost, costs, value), Service (service, staff, waiter, waiters), Ambience (ambience, atmosphere, decor), Social intent (boyfriend, date, birthday, lunch). Using these seed words, the iterative method of the present invention was implemented on the restaurant reviews dataset. The present invention quickly converged in 9 iterations and found semantic confidence scores with 7988 words. There was a high overall recall of 94% of the nouns in the corpus.

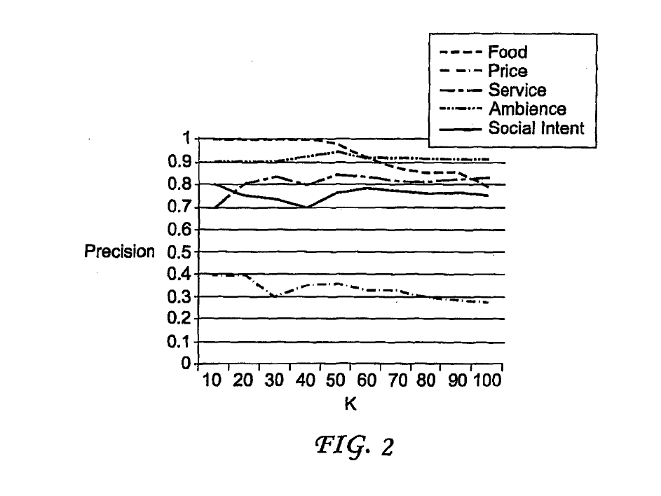

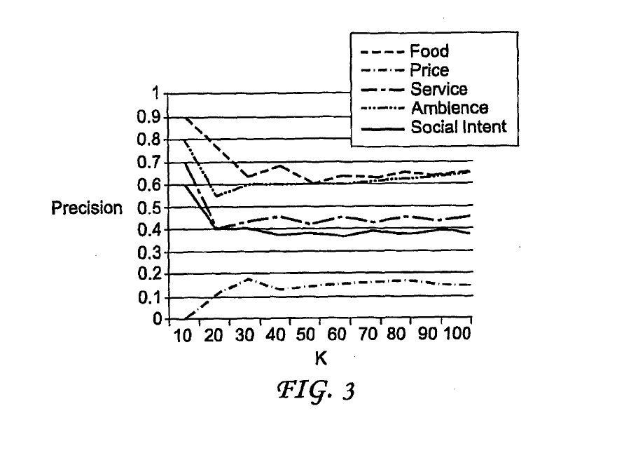

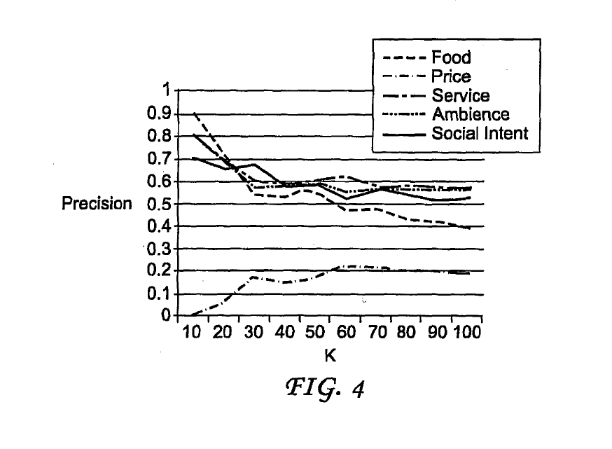

Since, no ground truth was available on the semantic meaning on words, the lists of words were manually evaluated, sorted by confidence score belonging to each semantic group, and the performance of the present invention was evaluated using precision at K. A high precision value indicates that a large number of the top-K words returned by the algorithm indeed belong to the semantic category. FIG. 2 shows the precision of the returned results for the five different semantic groups using the contextually guided method of the present invention. The figure shows that for four out of the five categories have a very high precision of over 80% evaluated with K=10, 20, . . . , 100. The Price category is the only category the present invention does not have very high precision. Users do not use many different nouns to describe the price of the restaurant and the metadata price level associated with the restaurant is sufficient for analyzing this topic. FIG. 3 shows the precision on the word co-occurrence graph, which does not use the contextual descriptor phrases to guide the semantics propagation. The price category still shows the poorest precision performance, but all other categories have a low precision around 60% after K=20. However, the contextual descriptors contain many words like adjectives and verbs other than the 8482 nouns used to build this graph. To explore whether using all words in the corpus help in semantics propagation, a co-occurrence model was built not just on the nouns but on all words in the data set. FIG. 4 shows the results for precision K for this word co-occurrence model on all words in the corpus. As shown, the precision slightly improves over the results in FIG. 3, but is still significantly poorer than the contextually guided results of FIG. 2. The context driven approach of the present invention very clearly outperforms the word co-occurrences method. Over large datasets contextual descriptor phrases are sufficient and more accurate at semantic propagation.

Inspection of the top-K word lists generated by the different models shows that the contextually driven method of the present invention assigns higher confidence scores to several synonyms of the seed words. For instance, some of the highest confidence scores for the Social Intent category were assigned to words like “bday, graduation, farewell and bachelorette”. In contrast, the word co-occurrence model assigns high scores to words appearing in proximity to the seed words like “calendar, bash, embarrass and impromptu”. The latter list highlights the fact that the word co-occurrence model assigns all words in a sentence to the same category as the seed words, which can often introduce errors. The contextually driven model of the present invention can better understand and distinguish between the semantics and meaning of words.

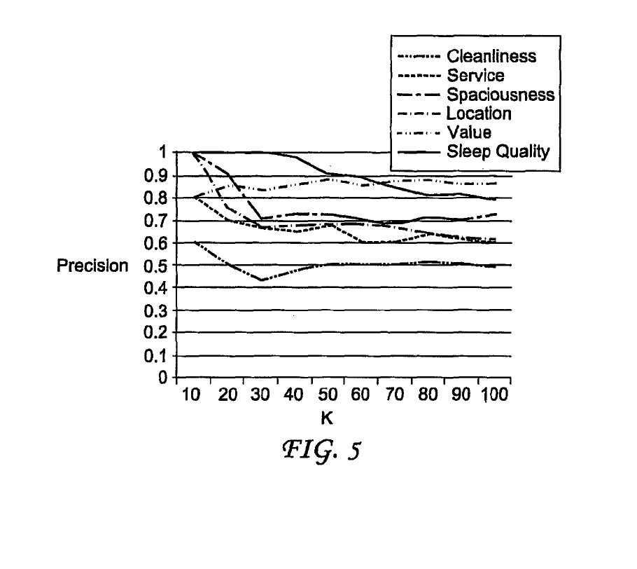

The hotel reviews in the corpus have an associated user provided rating along six features of the hotels: Cleanliness, Service, Spaciousness, Location, Value and Sleep Quality. These six semantic categories might not be the best division of topical information for the hotels domain. Users seem to write a lot on the location and service of the hotel and not so much on the value or sleep quality. However, in order to compare the effectiveness of the semantics propagation method of the present invention for predicting user ratings on individual aspects. For propagating semantic meaning on words, the same six semantic categories were adhered to in the experiments. Again, only a handful of seed words were used for each category. For the Cleanliness category, the seed set of {cleanliness, dirt, mould, smell} was used. The seed set {service, staff, receptionist, personnel} was used for the Service category. The seed set {size, closet, bathroom, space} was used for the Spaciousness category. The seed set {location, area, place, neighborhood} was used for the Location category. The seed set {price, cost, amount, rate} was used for the Value category and for Sleep Quality the seed set {sleep, bed, sheet, noise} was used. The choice of the seed words was based on the frequencies of these words in the corpus as well as their generally applicable meaning to a broad set of words. Using these seed words, the iterative method of the present invention was applied to the hotel reviews dataset. The method of the present invention quickly converged in eight iterations and discovered 10451 nouns, or 93% of all the nouns in the hotels corpus. This high recall of the method of the present invention is also accompanied with high precision as shown in FIG. 5.

FIG. 5 shows the precision at K (K=10, 20, . . . , 100) for the top-K highest confidence scores words for each of the six semantic categories in the corpus. There is a high precision (above 60%) for all categories except Value. These results however are slightly less precise in comparison to the results in the restaurants domain. It is believed that the reasons for these results were that the categories in the restaurants domain are better defined and distinct than in the hotels domain. In addition, the hotels corpus contains reviews for establishments in cities in Italy and Germany As a result, several travelers use words in foreign languages. While the method of the present invention does discover many foreign language words when used intermittently with English context, some of these instances result in adding noise to the process. Yet, the results using the method of the present invention are significantly better results in comparison to semantics propagation on a content only word co-occurrence graph.

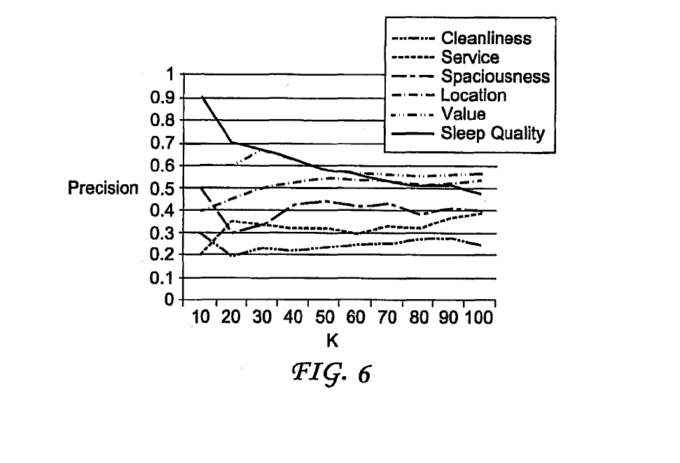

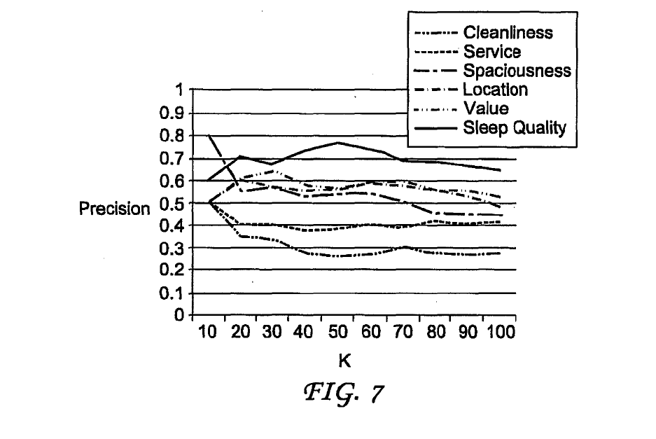

Similar to the restaurants comparison, FIG. 6 shows the precision for top-K results for propagating semantics on a co-occurrence graph built only on the nouns in the corpus. This graph assumes that two nouns used in the same sentence unit have similar meaning, and does not rely on the contextual descriptors to guide the semantics propagation. As shown in FIG. 6, the precision is significantly lower than the results in FIG. 5. Using words of all parts of speech for building the word co-occurrence graph improves the precision for the word classification slightly as shown in FIG. 7. However, these precision values are still poorer than the contextually driven semantics propagation method of the present invention.

The qualitative evaluation results clearly indicate the utility of contextual descriptors for finding highly precise semantic meaning on words. The benefit of discovering such semantic information is evaluated in learning user ratings along different semantic aspects of the products.

Most online reviewing systems rely predominantly on the mean rating of a product for assessing the quality. However as described in Example 1, users are often interested in specific features of the product. User experience in accessing reviews would greatly benefit if ratings on individual aspects of the product were provided. Such ratings could enable users to optimize their purchasing decisions along different dimensions and can help in ranking the quality of the products along different aspects.

The contextually driven method of the present invention “learns” scores for words to belong to the different topics of interest. The usefulness of these scores is now demonstrated in automatically deriving aspect ratings from the text of the reviews. A simple sentiment score is assigned to the contextual descriptors around the content words as described below. A rating for individual aspects is computed (determined) by combining these sentiment scores with the cluster membership confidence scores found by the inference on the words-context bipartite graph. Finally, the error in predicting the aspect ratings is evaluated.

The contextual descriptors automatically found by the method of the present invention often contain the polarized adjectives neighboring the content nouns. Therefore, it is believed that the positive or negative sentiment expressed in the review resides in the contextual descriptors. Since the contextual descriptors are learned iteratively from the seed words in the corpus, these descriptors along with the content words in the text in reviews are found (located, determined) with high probability. Therefore, instead of assigning a sentiment score to all words in the review or with the exponentially many word combinations in the text, the scores are assigned to a limited yet frequent set of contextual descriptors.

For a contextual descriptor d, the sentiment score Sentiment(d) is assigned as the average overall rating Rating(Overall)ᵣ of all reviews r containing d, as described in the following equation:

Sentiment(d)=(Σᵣ Rating(Overall)ᵣ)/Σᵣr (9)

Therefore, a descriptor that occurs primarily in negative reviews will have a highly negative sentiment score close to 1. This is an overly simplified score and more precise scoring methods have been proposed in previous studies. However, the focus of this paper is not on sentiment analysis. Rather, it is desired to demonstrate the usefulness of learning topical information over all words in a large dataset with little supervision. The elementary scoring function of Equation 9 for capturing the sentiment in reviews is satisfactory for this purpose. Thus, with every contextual descriptor found by the present invention, a numerical sentiment score in the range (1,5) is assigned.

The semantics propagation algorithm associates with each word w a probability of belonging to a topic or class c as Semantic(w, c). These semantic weights are used along with the descriptor sentiment scores from Equation 9 to compute the aspect rating for a review.

A review is analyzed at the sentence level and all (word, descriptor) pairs contained in the review text are found (located). Let w_{P} and d_{P} denote the word and descriptor in a pair P. Therefore, the raw aspect score for a class c, termed herein AspectScore(c), derived from the review text is the semantic weighted average of the sentiment score across the (word, descriptor) pairs in the text, is as described in the following:

AspectScore(c)=Σ_{P}[Semantic(w_{P},c)*Sentiment(d_{P})]/Σ_{P} Semantic(w_{P},c) (10)

The hotels dataset contains user provided ratings along six dimensions: Cleanliness, Service, Spaciousness, Location, Value and Sleep Quality as described above. The aspect ratings present in the dataset are used to learn weights to be associated with the raw aspect scores computed in Equation 10. In other words, a linear regression of the form y=a*x+b is solved, where the dependent variable y is the user provided aspect rating present in the corpus, b is the constant of regression and the variable x is the raw aspect score computed using Equation 10. Therefore, the final predicted aspect score learned from the text in the reviews is given by:

PredRating(c)=a*AspectScore(c)+b (11)

The accuracy of the aspect ratings derived from the textual component in the reviews is evaluated below and the usefulness of the semantic scores learned using the contextually guided algorithm is demonstrated.

For the experiments, 73 reviews from the hotels domain were randomly selected as the test set such that each review had a user provided rating for all of the six aspects in the domain: Cleanliness, Service, Spaciousness, Location, Value, Sleep Quality. The PredRating(c) for each of the six classes was then determined (computed, calculated) using two methods. First, the predicted score was determined (computed, calculated) using the Semantic(w) scores associated with the words w found using the semantic propagation algorithm. Alternately, a supervised approach was used for predicting the aspect rating associated with the reviews. For the supervised approach, a list of highly frequent words, which clearly belonged to one of the six categories, was manually created. This list included the seed words used in the learning method of the present invention and twice as many more additional words. Therefore, the predicted aspect rating using the Semantic(w) scores on these manually labeled 72 highly frequent words was computed (calculated, determined) with a 100% confidence of belonging to a certain category.

The error in prediction as computed (calculated, determined) using the popular RMSE metric. A low RMSE value indicates higher accuracy in rating predictions. In addition, the correlation between the predicted aspect ratings derived from the text in reviews and the user provided aspect ratings was evaluated. The correlation coefficient ranges from (−1, 1). A coefficient of 0 indicates that there is no correlation between the two sets of ratings. A high correlation indicates that the ranking derived from the predicted aspect rating would be highly similar to that derived from the user provided aspect ratings. Therefore, highly correlated predicted ratings could enable ranking of items along specific features even in the absence of user provided ratings in the dataset.

Table 2 shows the RMSE for making aspect rating predictions for each of the six aspects in the hotels domain. The first column shows the error when the semantics propagation algorithm was used for finding class membership over (almost) all nouns in the corpus. The second column shows the error when the manually labeled high frequency, high confidence words were used for making aspect predictions. The results in Table 2 show that for five of the six aspects, the RMSE errors for predictions derived from the semantics propagation method of the present invention are lower than the high quality supervised list. Moreover, the percentage improvement in prediction accuracy achieved using the semantics propagation method of the present invention is higher than 20% for the Cleanliness, Service, Spaciousness and Sleep Quality categories and is 12% for the Value aspect. In addition, Table 3 shows the correlation coefficient between the user-provided aspect ratings and the two alternate methods for predicting aspect rating from the text. For each of the six categories, the correlation is significantly higher when the semantics propagation method of the present invention is used, and is higher than 0.5 for the categories of Cleanliness, Service, Spaciousness and Sleep Quality.

TABLE 2

| | Contextually Guided | |
|---|---|---|
| | Semantics Propagation | Manually Labeled Words |
| Cleanliness | 0.834 | 1.042 |
| Service | 1.293 | 1.806 |
| Spaciousness | 0.996 | 1.302 |
| Location | 0.912 | 0.911 |
| Value | 1.445 | 1.649 |
| Sleep Quality | 1.357 | 1.703 |

TABLE 3

| | Contextually Guided | |
|---|---|---|
| | Semantics Propagation | Manually Labeled Words |
| Cleanliness | 0.540 | 0.338 |
| Service | 0.545 | 0.145 |
| Spaciousness | 0.604 | 0.414 |
| Location | 0.023 | −0.046 |
| Value | 0.420 | 0.245 |
| Sleep Quality | 0.503 | 0.255 |

The aspect rating prediction results indicate that there is benefit in learning semantic scores across all words in the domain. These semantic scores assist in deriving ratings from the rich text in reviews for the individual product aspects. Moreover, the semantics propagation method of the present invention requires only the representative seed words for each aspect and can easily learn the semantic scores on all words. Therefore, the algorithm can easily adapt to changing class definitions and user interests.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed Given the teachings herein, one of ordinary skill in the related art will be able to contemplate these and similar implementations or configurations of the present invention.

1. A method for operation of a search and recommendation engine via an internet website, said website operates on a server computer system, said method comprising:
accepting text of a product review or a service review;
initializing a set of words with seed words;
predicting meanings of said words in said set of words based on confidence scores inferred from a graph, wherein said graph is a bipartite graph of content words and context descriptors from said text; and
using the meanings of said words to make a recommendation for said product or said service that was a subject of said product review or said service review, wherein said confidence scores are used to make said recommendation.

2. The method according to claim 1, wherein said predicting act further comprises:
building said graph over active words and context descriptors and inferring said meanings of said words and said context descriptors;
determining if said meaning of one of said words is inferred with a high probability;
adding context descriptors containing said word to said set of active context descriptors, if said meaning of one of said words is inferred with said high probability;
repeating said determining and said adding acts for each of said words in said set of words;
determining if said set of context descriptors has changed;
one of building a new bipartite graph over active words and context descriptors and inferring said meanings of said words and said context descriptors and updating said previously built bipartite graph over active words and context descriptors and inferring said meanings of said words and said context descriptors, if said set of context descriptors has changed;
determining if said meaning of one of said context descriptors is inferred with a high probability;
adding words that appear in a context to said set of active words, if said meaning of one of said context descriptors inferred with said high probability;
repeating said determining and said adding acts for each of said context descriptors said set of context descriptors; and
determining if said set of context descriptors has changed and repeating said above acts if said set of context descriptors has changed.

3. The method according to claim 2, wherein said building acts, wherein said second building act is updating, further comprises:
building a symmetric data adjacency matrix;
building a diagonal degree matrix from said symmetric adjacency matrix;
building a normalized graph Laplacian from said diagonal degree matrix;
determine a harmonic solution of said graph Laplacian; and
determining a probability that one of said words or one of said context descriptors is in a category.

4. The method according to claim 3, wherein said harmonic solution of said graph Laplacian represents a confidence score.

5. The method according to claim 1, wherein said search and recommendation engine is accessible from a user device.

6. The method according to claim 5, wherein said user device is one of a computer, a laptop, a mobile terminal, a dual mode smartphone, an iPhone, an iPod, an iPad, and a tablet.

7. A search and recommendation engine operated via an internet website, said website operating on a server computing system, comprising:
a generate bipartite graph module;
a generate adjacency graph module, said generate adjacency graph module in communication with said generate bipartite graph module;
a predict confidence score module, said predict confidence score module in communication with said generate adjacency graph module; and
a recommendations module, said recommendations module in communication with said predict confidence score module.

8. (canceled)

9. (canceled)

10. (canceled)

11. (canceled

12. The search and recommendation engine according to claim 7, wherein said search and recommendation engine is accessible from a user device.

13. The search and recommendation engine according to claim 12, wherein said user device is one of a computer, a laptop, a mobile terminal, a dual mode smartphone, an iPhone, an iPod, an iPad, and a tablet.

14. The search and recommendation engine according to claim 7, wherein said generate bipartite graph module outputs words and context descriptors to the generate adjacency matrix module.

15. The search and recommendation engine according to claim 7, wherein said generate adjacency matrix module outputs the adjacency matrix to the predict confidence scores module.
